(19) United States
(12) Patent Application Publication
(10) Pub. No.: US 2008/0256178 A1
(43) Pub. Date: Oct. 16, 2008

(54) Method and Apparatus for Providing Software by Functional Units in a Software Streaming System

(75) Inventors: Won-Young Kim, Daejeon (KR); Wan Choi, Daejeon (KR); Jeong-Min Shim, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Instit, Daejeon-city (KR)

(21) Appl. No.: 12/088,073

(22) PCT Filed: Dec. 7, 2006
(86) PCT No.: PCT/KR2006/005295

§ 371 Date: Mar. 25, 2008

(30) Foreign Application Priority Data
Dec. 8, 2005 (KR) 10-2005-0120156
Dec. 7, 2006 (KR) 10-2006-0123734

(51) Int. Cl. G06F 15/16

(52) U.S. Cl. 709/203

(57) ABSTRACT

A method and apparatus for providing software by function units are provided. In the method, at the streaming client, a functional unit identification is created for identifying a function requested from a user by intercepting a request of a predetermined function in application software from a user. Then, it determines whether a functional unit corresponding to the created functional unit identification is streamed or not, and determines whether each of execution pages of the functional unit is streamed or not when the functional unit is not streamed. After determining, a streaming list is composed with execution pages that are not streamed based on the determination result. Then, a streaming service is requested by transmitting the composed streaming list to the streaming server, and execution pages transmitted from the streaming server are received and stored.

### TECHNICAL FIELD

The present invention relates to a software streaming service and, more particularly, to a method and apparatus for providing software by function units in order to stream execution pages required for performing predetermined functions of software at once in a software streaming system.

### BACKGROUND ART

A software streaming service is a service technology to execute a software execution code in a streaming server at a client through streaming.

FIG. 1 is a block diagram illustrating a procedure for transmitting and receiving control data and streaming data related to application software execution between a streaming server and a client for providing a software streaming service according to the related art.

Referring to FIG. 1, a streaming client 110 and a streaming server 120 are connected through a communication network such as the Internet for the software streaming service.

The streaming client 110 is installed at a user terminal for receiving a streaming service. The streaming client 110 transmits a request of an execution code for executing application software to the streaming server 120.

The streaming server 120 receives the request for executing application software from the streaming client 110. Then, the streaming server 120 finds the requested execution code from entire execution code 130 of application software, that is, predetermined execution pages, according to the received request, and transmits the found execution code to the client 110 through the Internet.

The streaming client 110 receives execution pages of the application software from the streaming server 120 and performs the received execution pages, thereby using application software not installed in the streaming client 110 like as application software installed in the streaming client 110.

Since the conventional software streaming service, however, is provided by execution page units, it requires the streaming client to repeatedly request a related streaming service and receive execution pages as many as the number of execution pages necessary for performing a corresponding function in order to perform the pre-determined function of application software.

For example, if a printing function of predetermined application software needs five execution pages, the streaming client 110 repeatedly requests a related streaming service to the streaming server 120 and receives execution pages five times to perform the printing function.

In case of providing a streaming service by execution page units as described above, the execution of requested function may be delayed due to the repeated requests and receiving processes as many as the number of information required for performing the predetermined function.

If a predetermined portion of information is not received because a related network is malfunctioned while repeatedly requesting and receiving streaming as many as information required for performing the predetermined function of application software, the software streaming service is interrupted.

### DISCLOSURE OF INVENTION

### Technical Problem

An aspect of the present invention is to provide a method and apparatus for providing software by function units in order to stream execution pages required for performing a predetermined function of software at once in a software streaming system.

### Technical Solution

According to an aspect of the invention, the invention provides a method for providing software by function units in a software streaming system including a streaming client and a streaming server, including: at the streaming client, creating a functional unit identification for identifying a function requested from a user by intercepting a request of a predetermined function in application software from a user; determining whether a functional unit corresponding to the created functional unit identification is streamed or not; determining whether each of execution pages of the functional unit is streamed or not when the functional unit is not streamed; composing a streaming list with execution pages that are not streamed based on the determination result; requesting a streaming service by transmitting the composed streaming list to the streaming server; and receiving execution pages transmitted from the streaming server and storing the received execution pages.

According to another aspect of the invention, the invention provides an apparatus for providing software by functional units in a software streaming system including: a function recognition library for creating a functional unit identification to identify a function requested from a user by intercepting a request of a function in application software from a user; a streaming controller for requesting streaming of a functional unit corresponding to the created functional unit identification from the function recognition library and for receiving execution pages included in a functional unit transmitted from the streaming server; and a local cache for storing the streamed execution pages.

### ADVANTAGEOUS EFFECTS

A method and apparatus for providing software by function units according to certain embodiment of the present invention allows a streaming client to receive execution pages, which are requested by function units of software, at once. Therefore, the number of communications between a streaming server and the streaming client is reduced, and a streaming time is also shortened, thereby improving the service quality thereof. According to the certain embodiments of the present invention, a streaming controller is independently embodied separately from a streaming file system filter. Such a structure allows easy porting of client engine, and various services can be provided by providing various streaming policies from a streaming controller that is a typical process, not an operation system. Since the execution pages are provided by function units, corresponding application software can be limitedly used based on the streamed functional unit although a related network is malfunctioned while using a streaming service. Moreover, by providing software by function units, it is possible to charge a service fee for a streaming service by function units.

### BRIEF DESCRIPTION OF THE DRAWINGS

FIG. 1 is a block diagram illustrating a software streaming service system according to the related art;

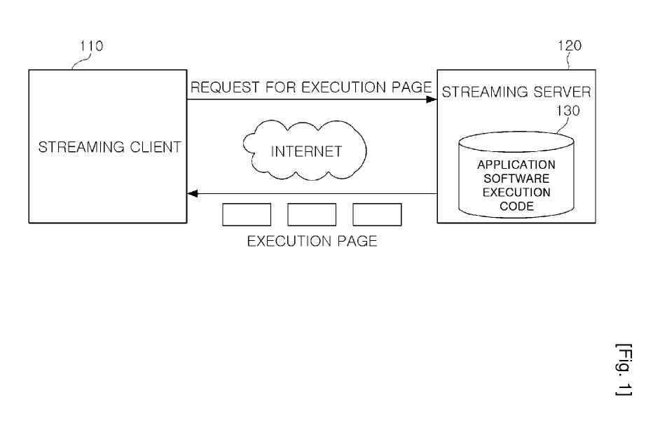

FIG. 2 is a block diagram illustrating a streaming client according to an embodiment of the present invention;

FIG. 3 is a diagram for describing the configuration of functional unit according to an embodiment of the present invention;

FIG. 4 is a flowchart illustrating the operation of a streaming client according to an embodiment of the present invention; and

FIG. 5 is a flowchart illustrating the operation of a streaming file system filter according to an embodiment of the present invention.

### BEST MODE FOR CARRYING OUT THE INVENTION

Hereinafter, preferred embodiments of the present invention will be described in detail with reference to the attached drawings. Although the same elements are shown in different drawings, the same numeral references denote the same elements. Herein, the detailed descriptions may be omitted if a constituent element is well known, or if it makes the description of the present invention unclear.

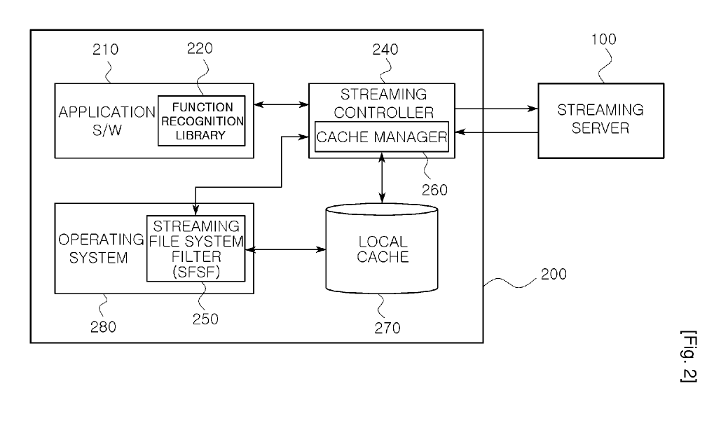

FIG. 2 is a block diagram illustrating a streaming client according to an embodiment of the present invention.

Referring to FIG. 2, the streaming client 200 according to the present embodiment includes a function recognition library 220, a streaming controller 240, a local cache 270, and a streaming file system filter (SFSF) 250. The function recognition library 220 intercepts are a request of a predetermined function from a user for streamed application software 210, creates a functional unit identification corresponding to the requested function, and requests a related streaming service to the streaming controller 240. The streaming controller 240 manages the states of streaming by function units, and determines whether a streaming service of a function unit requested from the function recognition library 220 is provided or not. If not, the streaming controller 240 determines whether execution pages included in the corresponding functional unit are not streamed or not. Then, the streaming controller 240 composes a streaming list with execution pages not previously streamed, and receives the execution pages of the streaming list from the streaming server 100 at once. The local cache 270 stores execution pages streamed by the streaming controller 240. The streaming file system filter (SFSF) 250 processes a file calculation or a page fault generated while executing the streamed application software 210.

Herein, the functional unit denotes a set of execution pages required for performing any function of application software. The functional units are managed by the functional unit identification that is a unique identification of a functional unit. It assumes that a list of execution pages included in a predetermined functional unit is previously defined. The function recognition library always generates the same function unit identification of the same function unit.

The application software 210 is typical application software linked to the function recognition library. By replacing or adding the library of the application software 210 to have a function of generating a functional unit identification, a function requested by a user can be recognized and a streaming service can be provided by function units without modifying application program.

The streaming controller 240 includes a cache manager 260 for managing the local cache 270 and stores the streamed execution pages into the local cache 270 through the cache manager 260. The streaming controller 240 also confirms or reads the execution pages stored in the local cache 270 and provides the read execution pages to the application software 210 through the cache manger 260.

Furthermore, the SFSF 250 determines whether a page with a fault is stored in the local cache 270 or not when a page fault is generated from a predetermined page while a predetermined function is performing. If the page with fault is not stored in the local cache 270, the SFSF 250 requests the streaming service of a corresponding execution page to the streaming controller 240 and returns the corresponding execution page received as a result thereof to the operating system 280. When the streaming controller 240 receives a request of a predetermined execution page from the SFSF 250, the streaming controller 240 determines whether the requested execution page is included in the current streaming list or not. If it is in the current streaming list, the streaming controller 240 provides an execution page to the SFSF 250 after completely streaming the streaming list. If not, the streaming controller 240 requests a corresponding execution page to the streaming server 100 and provides the execution page received from the streaming server 100 to the SFSF 250.

As described above, the streaming client 240 can receive execution pages to perform any function of application software by requesting it to the streaming server 100 at one time. In order to receive the execution pages with one time request, the streaming client 200 according to the present embodiment sets and manages the functional unit that is a set of execution pages required by functions performed in application software.

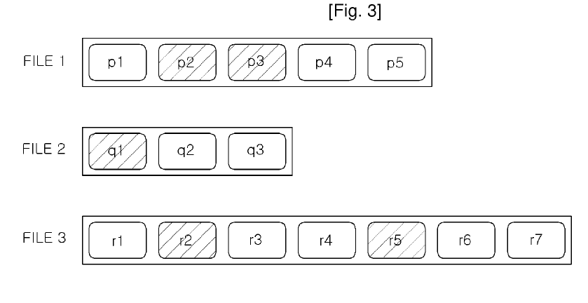

FIG. 3 is a diagram for describing a function unit according to an embodiment of the present invention.

Referring to FIG. 3, it assumes that a predetermined function in application software, for example a printing function, requires execution pages p2, p3, q1, r1, and r5 in three different files, a first file 1, a second file 2, and a third file 3. A functional unit for performing the printing function in the application software is formed of the execution files p2 and p3 in the first file 1, the execution file q1 of the second file 2, and the execution files r2 and r5 of the third file 3. Such a functional unit is identified by a unique identification. When a user requests the printing function to the application software 210, the function recognition library 220 intercepts the request of printing function, creates the functional unit identification for the printing function, and transmits the created functional unit identification to the streaming controller 240.

Then, the streaming controller 240 in the streaming client 200 requests the streaming service for the execution pages p2, p3, q1, r2, and r5 of the functional unit corresponding to the functional unit identification at one time and receives the requested execution pages at once.

Herein, the same execution pages per each function may overlap. That is, previously streamed execution pages for performing different function may be included in a currently requested functional unit. In order to avoid streaming unnecessary execution pages, the streaming controller 240 checks each of execution pages in a functional unit whether it is previously streamed or not, composes a streaming list with execution pages not previously streamed, and transmits the composed streaming list to the streaming server 100, thereby receiving the streaming service of the execution pages.

Herein, the streaming controller 240 performs asynchronous file input/output and synchronous transmission with a server while being operated with at least one of threads or processes, thereby preventing the performance from being degraded due to direct network delay or I/O delay.

### MODE FOR THE INVENTION

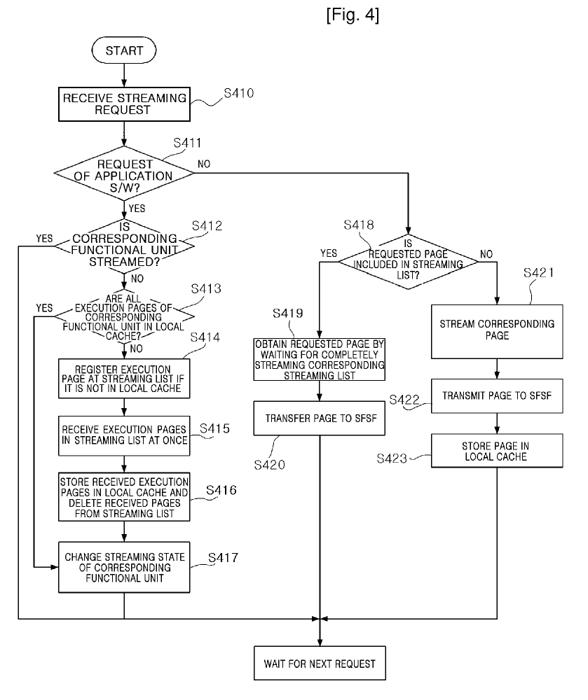

FIG. 4 is a flowchart illustrating a method for providing software by function units in a streaming client 200 according to an embodiment of the present invention. With reference to FIG. 4, the method for providing software by functional units will be described.

If a user selects a predetermined function after selected application software is received through a streaming service, the function recognition library 220 of the application software requests the streaming service of a functional unit corresponding to the selected function to the streaming controller 240. That is, the function recognition library 220 creates a functional unit identification for the requested function and transmits the created identification, thereby requesting the streaming request of the functional unit.

As described above, the function recognition library 220 requests the streaming service for the functional unit at steps S410 and S411. Then, the streaming controller 240 determines whether a streaming service of a corresponding functional unit is provided or not by confirming a functional unit corresponding to the functional unit identification at step S412. In order to determine, the streaming controller 240 manages the streaming state value of a corresponding function unit as a streaming completion state after providing the streaming service of a predetermined functional unit. At the step S412, the streaming controller 240 confirms whether the streaming state value of the functional unit is the streaming completion state value or not.

At the step S412, if the requested functional unit is in the streaming completion state, the streaming controller 240 waits for the next request because additional streaming request is not necessary.

At the step S412, if the requested functional unit is not in the streaming completion state, it determines whether execution pages of the requested function unit are streamed and stored in the local cache 270 or not at step S413.

If the all of execution pages of the corresponding functional unit are in the local cache 270, the streaming state value of the corresponding function unit changes to the streaming completion state at step S417 because additional streaming for execution pages is not necessary. Then, it waits for the next request.

At the step S413, if the execution pages are not stored in the local cache 270, a streaming list is composed by registering execution pages not stored in the local cache 270 at step S414. Then, the streaming service is requested to the streaming server 100 at once by transmitting the composed streaming list, and the requested execution pages are received through the streaming service at once at step S415. Herein, although the streaming request from the streaming client 200 to the streaming server 100 is performed at once, the streaming server 100 may asynchronously transmit the requested execution pages to the streaming client 200.

The streaming controller 240 stores execution pages asynchronously received from the streaming server 100 according to the request in the local cache 270, and the execution pages stored in the local cache 270 are deleted from the streaming list at step S416.

After streaming all execution pages in the corresponding streaming list, the streaming state value of the corresponding function unit changes to the streaming completion state, and it waits for the next request at step S417.

After completely streaming all execution pages, the execution pages of the corresponding functional unit stored in the local cache 270 are provided to the application software 210 by the SFSF 250.

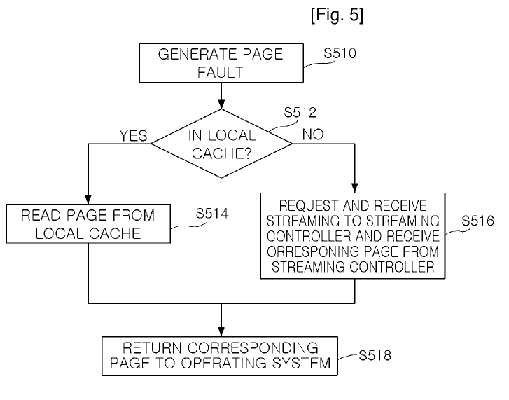

While the application software 210 performs the streamed execution pages, a page fault may be generated for a predetermined execution page. The SFSF 250 performs a necessary operation to process the page fault. The operation of the SFSF 250 will be described with reference to FIG. 5, hereinafter.

When a page fault is generated, the SFSF 250 confirms whether a corresponding execution page is present in the local cache 270 or not at step S512.

If the corresponding execution page is in the local cache 270, the corresponding execution page is read from the local cache 270 and is returned to the operation system at steps S514 and S518.

On the contrary, if the corresponding execution page is not present in the local cache 270, the SFSF 250 requests the streaming controller 250 to stream a corresponding page, receives the pages streamed from the streaming controller 240 at step S516, and returns the received execution page to the operation system 280 at step S518.

The operation of the streaming controller 240 for the execution page request from the SFSF 250 will be described with reference to FIG. 4 again.

As described above, when the streaming controller receives a streaming request for a page with page fault from the SFSF 250, the step S418 is performed to confirm whether the requested execution page is in the previous streaming list or not because it is not the request of the application software 210 at the step S411.

If the requested execution page is in the previous streaming list, it waits for completely streaming execution pages in the streaming list. After completely streaming the execution pages, the streamed corresponding page is transferred to the SFSF 250 at steps S419 and S420. On the contrary, the corresponding execution page is not included in the streaming list, the streaming controller 240 requests the streaming service for a corresponding execution page to the streaming server 100 at step S421. Then, the streaming controller 240 receives the corresponding execution page streamed from the streaming server 100, transfers the received execution page to the SFSF 250, and stores it in the local cache 270 at steps S422 and S423.

### INDUSTRIAL APPLICABILITY

The method and apparatus for providing software by function units according to the certain embodiments of the present invention can be applied to a software streaming service field and can stream execution pages required for performing a predetermined function of software at once in a software streaming system.

1. A method for providing software by function units in a software streaming system including a streaming client and a streaming server, comprising: at the streaming client,
creating a functional unit identification for identifying a function requested from a user by intercepting a request of a predetermined function in application software from a user;
determining whether a functional unit corresponding to the created functional unit identification is streamed or not;
determining whether each of execution pages of the functional unit is streamed or not when the functional unit is not streamed;
composing a streaming list with execution pages that are not streamed based on the determination result;
requesting a streaming service by transmitting the composed streaming list to the streaming server; and
receiving execution pages transmitted from the streaming server and storing the received execution pages.

2. The method according to claim 1, further comprising setting a streaming state value of a corresponding functional unit to a streaming completion state when all execution pages corresponding to the requested functional unit are streamed and stored.

3. The method according to claim 1, further comprising:
confirming whether a corresponding page is streamed and stored or not if a page fault is generated while a predetermined function of application software is performed;
determining whether the page is included in the streaming list or not if the corresponding page is not stored; and
waiting for a corresponding streaming list if the corresponding page is stored in the streaming list, and requesting the streaming server to stream a corresponding page only if the corresponding page is not in a streaming list.

4. The method according to claim 1, wherein in the step of creating the functional unit identification, the functional unit identification is created by detecting a function request of a user without modifying application software by replacing or adding a library of a corresponding software.

5. The method according to claim 1, wherein in the step of receiving execution pages, execution pages of a corresponding streaming list are asynchronously received.

6. An apparatus for providing software by functional units in a software streaming system comprising:
a function recognition library for creating a functional unit identification to identify a function requested from a user by intercepting a request of a function in application software from a user;
a streaming controller for requesting streaming of a functional unit corresponding to the created functional unit identification from the function recognition library and for receiving execution pages included in a functional unit transmitted from the streaming server; and
a local cache for storing the streamed execution pages.

7. The apparatus according to claim 6, wherein the streaming controller manages a streaming state of a functional unit, confirms the streaming state of a functional unit corresponding to the functional unit identification created from the function recognition library, and requests a streaming service to a streaming server by composing a streaming list with execution pages not streamed among execution pages of a corresponding functional unit if the confirmed streaming state is not a streaming completion state.

8. The apparatus according to claim 7, wherein the streaming controller deletes execution pages received from a streaming server from the streaming list, and sets a corresponding functional unit as a streaming completion state if all execution pages are deleted from the streaming list.

9. The apparatus according to claim 6, wherein the streaming controller includes a cache manager for managing the local cache and storing received execution pages at a local cache.

10. The apparatus according to claim 8, further comprising a streaming file system filter included in an operating system for processing a fault of a page requested from the application software and processing a file process request.

11. The apparatus according to claim 10, wherein if a corresponding execution page is not stored in the local cache when a page fault is generated while performing the application software, the streaming file system filter requests streaming of a corresponding page to the streaming controller and receives a corresponding page from the streaming controller.

12. The apparatus according to claim 11, wherein when the streaming file system filter requests streaming, the streaming controller determines whether a corresponding page is in the streaming list or not, waits until the streaming list is streamed if it is included, and requests streaming of a corresponding page to the streaming server if it is not.
